(19) United States
(12) Patent Application Publication
(10) Pub. No.: US 2007/0282717 A1
(43) Pub. Date: Dec. 6, 2007

(54) Electronic Stock Control and Auditing of Detonator Use

(75) Inventor: Peter Shann, York (GB)

Correspondence Address: JACOBSON HOLMAN PLLC, 400 SEVENTH STREET N.W., SUITE 600, WASHINGTON, DC, 20004, US

(73) Assignee: ADVANCED BLASTING TECHNOLOGY, INC., WATERTOWN, NY (US)

(21) Appl. No.: 11/659,732

(22) PCT Filed: Aug. 8, 2005
(86) PCT No.: PCT/GB05/03115

§ 371 Date: Jul. 20, 2007

(30) Foreign Application Priority Data
Aug. 9, 2004 (GB) 0417635.0

(51) Int. Cl. F42D 5/02

(52) U.S. Cl. 705/28

(57) ABSTRACT

A system for recording the use of individually identifiable detonators is described, the system comprising a data log of identified detonators; means to record electronically when a detonator is committed to fire; means to alter the data log to log as consumed a detonator recorded as so committed. A detonator is recorded as committed to fire only either when a detonator is intrinsically and irrevocably committed to fire or when an abort facility is set up in such manner that the system operates to remove the log entry of detonator consumption in the event that an abort signal is given. A method of recording the use of individually identifiable detonators is also described.

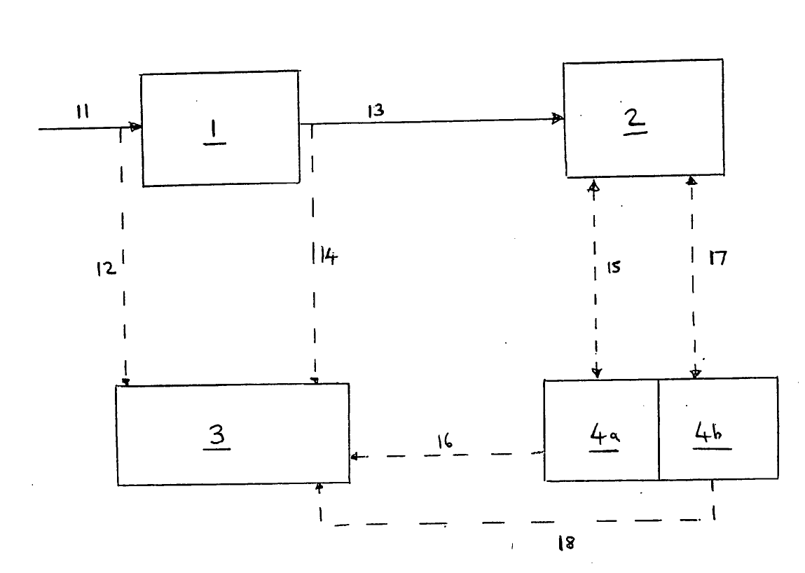

The invention relates to a practical and reliable method of verifying and logging detonator usage, of particular relevance in a mining and quarrying environment.

In a modern complex mining environment it is becoming increasingly difficult to determine with certainty that the often many hundreds of detonators allocated for or placed in each shot have all fired, leading to live detonators being found in the rock pile creating a hazard within both the quarrying environment and in products leaving the quarry. Also a potential for theft of detonators exists by ether removing detonators from the rock face prior to firing, or by falsifying detonator use records.

Previous publication WO00/60305, Logging of Detonator Usage, proposes what claims to be a system of logging detonator destruction. This has a potential for errors in that a system of logging the instance of detonator actual destruction is not defined within the disclosure or practicably possible. Rather, detonator destruction is recorded based on inferences drawn from an earlier stage in the programming cycle, for example by identifying the detonator and its “ready to fire” state. Destruction is inferred when a firing signal is given to a detonator previously identified as ready to fire. There is a problem with this approach, since mere identification of a detonator at a given point in time as being ready to fire does not mean that the detonator is irreversibly or intrinsically committed to fire and the logging of detonators signalling their identity code or “ready to fire” state is temporally prior to, and therefore not an implicit verification of actual detonator destruction.

For example long delays and system aborts and rearrangements including removal of detonators can occur both before and after detonators signalling their identity code or ‘ready to fire’.

Also, within rock blasting it is often advantageous and efficient to ensure a time delay sequence between each explosive filled bore hole, arranged to ensure that bore holes nearest a free and unconfined rock face with least restriction are fired first with a subsequent progression of firings ordered to enable rock flow towards the newly formed and growing free face. Delays are also used so as to divide the total explosive usage per blast into small separately delayed explosions reducing the maximum instantaneous charge weight and ground vibrations. Historically this has been achieved by incorporating a pyrotechnic delay train in each detonator with modern electronic addressable detonators superior system accuracy and flexibility is possible. This introduces a further temporal and functional degree of separation between recordal of identity or ready state and final destruction.

The system in WO00/60305 fails to ensure a secure loop within which to reliably determine detonator destruction, since the logging described in WO00/60305 draws inferences from an event which is disconnected temporally and functionally to, too great an extent from the destruction event for reliable prediction to be made. The present invention aims to automate the logging of authorised detonator usage, but only when the detonator is committed to fire

Accordingly, the invention in a first aspect provides a system for recording the use of detonators comprising means to record electronically when a detonator is committed to fire; means to log as consumed, for example by making an entry in a suitable data log, a detonator recorded as so committed.

In contrast to the prior art, which merely records that a detonator has indicated a ready to fire state at some time in the past, and then infers detonation merely from the sending of a firing instruction, the log in accordance with the present invention is only updated when a “committed to fire” condition is identified for the detonator in question. Consumption of the detonator is recorded by the system only when detonators are either intrinsically and irrevocably committed to fire, or where a detonator designed with an abort facility after commitment to fire is set up such that the log entry of detonator consumption is removed when an abort signal is given.

That is to say, a consumption of a detonator is recorded only when a committed to fire condition is identified which is either irrevocable regardless of any subsequent signal or other action in connection with the detonator, or is revocable only in circumstances where a generated abort signal follows the original instruction to fire, which generated abort signal also serves to reverse the log of the detonator as consumed. A system in accordance with the invention may include a plurality of detonators operating on the first basis and/or a plurality of detonators operating on the second basis.

The common feature in all embodiments of the invention is that once a committed to fire state is identified, detonation will either proceed or will require a centrally generated abort signal to be prevented. In this sense, the detonator is intrinsically committed to fire. Therefore the degree of certainty is much greater than where detonation is presumed following mere recordal of a ready signal and subsequent recordal of an instruction to fire.

Each detonator may be individually identifiable, for example based on the fact that present day detonators are usually provided with an identification code which must first be recognised at a firing control station before a firing signal is transmitted to the detonator at the appropriate time for the desired blasting sequence. Alternatively, detonators may be identified collectively, with the log serving as an indication as to whether a whole batch has been succesfully consumed.

The data log may comprise an inventory control system to log inventory data, including at least data concerning whether the detonator is recorded as consumed, and optionally also data concerning whether the detonator is stored in a remote safe controlled store, has been removed for deployment, has been deployed etc. In a typical system, detonators are delivered in quantity to a first, safe controlled store, and subsequently removed for deployment. The data log conveniently comprises an inventory control system to include data at least identifying all detonators supplied to stock, for example all detonators supplied to one or more controlled stores, and data concerning whether consumption of a detonator has been recorded and optionally further including data concerning whether a detonator has been removed from the store and/or whether a detonator has been deployed at a blast site.

A firing control is provided within the system in communication with each blast detonator and with the data log to send a fire initiation signal to each blast detonator and to record the identity of each detonator in familiar manner. The firing control conveniently also comprises means to determine and record electronically a committed to fire condition from each blast detonator.

Three types of committed to fire conditions are envisaged.

In a first alternative, a detonator is provided arranged so that on receipt of a fire initiation signal initiating its explosion the detonator is irreversibly committed to explode even if completely disconnected, the system being set such that on forwarding the initiation signal the consumption of the detonator is recorded.

In this first alternative, inferences are drawn from the sending of the initiation signal, and from this detonation is presumed. This is acceptable only when the detonator is adapted to detonate irrevocably, even if disconnected from the system, when a firing instruction has been received. Thus, in this circumstance only, it is reasonable to infer a committed to fire state even in the circumstances indicated.

However, even this does not entirely obviate the risk of circuit disruption. Accordingly, in accordance with the second and third preferred alternatives below, a detonator is provided with means to communicate a response confirming receipt of the fire signal back to the firing control, and in a preferred embodiment means to communicate that it is committed to fire, and is arranged so that on receipt of a signal initiating its explosion sequence the detonator is adapted to communicate that it is in receipt of the initiation signal and in a preferred embodiment that it is committed to fire, the system being configured such that only on receipt of such a response at the firing control is the detonator's consumption logged.

In accordance with the second alternative, the detonator is adapted to generate a communication that it is committed to fire only once it has been irrevocably so committed. This eliminates the possibility of any interference in the communication chain, and gives much greater certainty that in a situation where a detonation event is logged it has actually occurred.

Such a system is particularly suited to a detonator that has a delay before firing on receipt of an initiation signal. Accordingly, as an example of this second alternative, the detonator is a communicable delay detonator arranged so that on receipt of a signal initiating its explosion sequence the detonator communicates that it is committed to fire and only on receipt of such signal is the detonator's consumption logged.

In a third alternative, a detonator is provided wherein detonation can be aborted following transmission of an initiation signal, but only by subsequent transmission of a second, abort signal, and the detonator is arranged so that on receipt of a signal initiating its explosion sequence the detonator communicates that it is committed to fire and a log is made of the detonator's consumption, but that on forwarding the abort command the record of the detonator's consumption is removed from the log. Again, this alternative is particularly suited to, but not limited to, a communicable delay detonator.

A plurality of detonators may be provided, and a practical system will include a large plurality of detonators, some of which may operate in accordance with any or all of the above.

Whereas the invention will not record the actual destruction of detonators it records an event sufficiently close to destruction that it would be impractical to remove a detonator from the system after identification of a “committed to fire” state (e.g. receipt of the fire command or the detonator signalling its commitment to fire). Typically explosion would occur within a maximum of a few seconds and even if the wires were cut, would be irreversibly and intrinsically committed to occur running on its internal timer. Making a recordal of consumption based on a state of “committed to fire” as hereinbefore defined provides a greater degree of certainty of actual destruction than a recordal based on mere readiness, thus providing a reliable record of detonator usage. Data logged could be used to improve operating safety and process efficiency within the quarrying environment, and if held in a secure form with strong, secure stock control and auditing, could be used to prevent and deter criminal access to detonators.

A further improvement in practical implementation and system reliability can be achieved by ensuring data logging from all delay detonators in the shot has taken place prior any detonator firing, as system integrity and wiring to unfired detonators can be disrupted by earlier sequenced explosive charges firing during the time frame that the shot is sequenced, leading to uncertainty as to the actual numbers of detonators consumed.

In accordance with the invention, there is a recognition that within a mining environment it is not practically possible to log the instance of, or post verify, actual detonator destruction. However, the present invention provides a much more secure logical loop within which to reliably predict with a very high degree of certainty that a detonator has been consumed than was possible with the prior art. This provides a practical solution to prevent detonators going astray within the constraints of real world mining conditions.

The invention is readily adaptable to a complete inventory system to allow tight control to be kept over the supply to store, the subsequent removal from store, optionally the details of deployment, and with much increased reliability, the destruction of deployed detonators. If use is made of a manufacturer or supplier coding, complete traceability from manufacturer or supplier is possible.

In use, a plurality of detonators are deployed in communication with a central firing control. Each detonator is adapted to transmit a unique identification code on interrogation from the central firing control in familiar manner, and will for example store a unique identification code on a suitable passive or active chip device in familiar manner. To enable the system to be used to maintain an inventory of detonators through the supply and detonation process, the system preferably includes means to identify each detonator for example on its receipt at the controlled store, and on its supply from the controlled store for use at a blast site. These may comprise means to read the chip associated with each detonator and/or additional readable means on the detonator, such as a barcode or the like.

The detonators which can be controlled in usage by the system of the invention may be of any suitable type, and in particular may include simple detonators which commit irrevocably to detonation on receipt of an initiation signal, and detonators incorporating a time delay.

Suitable data communication means are provided in the familiar manner to allow a firing control to communicate with each blast detonator at the blast site, to transmit a firing initiation signal to the blast detonator, to identify “a committed to fire” state for the blast detonator, and in particular to receive a committed to fire signal from the blast detonator, and to transmit consumption data to the inventory data log. Further communication means are preferably provided from the controlled detonator store to the data log to identify detonators on arrival at the controlled store and/or on onward supply to the blast site. Data communication means may be of any suitable form, for example wired or wireless in familiar manner, via an ethernet link etc.

Reference to a controlled store is to any detonator storage facility where detonators can safely be stored prior to use in secure conditions. It might for example include a store at a manufacturing site, a store at distribution site, a store provided by an end user either at the blast site or an alternative secure location. A system in accordance with the invention is capable of providing an inventory dealing with multiple such controlled storage sites.

The data log preferably comprises an electronic register, and in particular a secure electronic register, protected by a security system for example including suitable encryption and/or access controls, to be proof against or at least allow detection of tampering. The electronic register may be located at the firing control site or at a remote site in data communication therewith. Larger scale systems, for example to cater with multiple sites, can be envisaged in which a plurality of such data logs are provided in data communication, for example on a distributed network. Complete traceability is possible even over multiple sites.

In accordance with the invention in a further aspect, a method of recording the use of detonators comprises the steps of:

providing a fire control station in data communication with each detonator in use, using the fire control station to identify a “committed to fire” state for a detonator, in particular by receiving a committed to fire signal from the detonator following transmission of a firing initiation signal from the fire control station;

logging consumption based on the committed to fire state, and communicating the consumption of the detonator to a data log.

In particular, the method is a method of recording the use of individually identifiable detonators, for example an inventory control method, and comprises the further steps of:

maintaining a data log comprising inventory data of identified detonators, including at least an identification of the detonators, and a recordal of whether they have been consumed, and in a preferred embodiment further including recordal of supply of detonators to a controlled store, and recordal of removal of detonators for use;

logging consumption by updating the data log to register consumption of the identified detonator.

Other detailed preferred features of the method in accordance with the invention will be inferred by analogy from the foregoing discussion of the system in accordance with the invention.

An example of a system in accordance with the invention will now be described with reference to the accompanying schematic diagram. In the diagram, physical transfer of detonators is represented by solid lines, and data communication by broken lines. The illustrated system is provided by way of example only.

Referring to the illustration, four principal locations are shown, these being the controlled detonator store 1, the detonation site 2, the data log 3, and the firing control centre 4, which for convenience is shown subdivided, representing its two primary functions in accordance with the invention, identifying each deployed detonator at the blast site 4a, and determining a committed to fire state 4b.

The representation of physically separate units is schematic only and not determinative of location. The firing control system 4 will be in the vicinity of but at a safe location away from the immediate blast location 2. The controlled store 1 may be at a safe location convenient for the blast site 2 or elsewhere. The data log may be located at the firing control centre, or elsewhere, or may comprise multiple data stores at distributed locations.

A supply 11 of suitably coded detonators is made to the controlled store 1. This supply is recorded via data link 12 at the inventory log 3. On removal 13 of detonators from the store for deployment at the blast site, a further piece of inventory information 14 may be transmitted to the inventory log.

Each detonator has a unique electronic code which can be read at the detonation site 2 by the firing control system 4a by means of the data link 15. An additional data link 16 may be provided to allow this identification in situ to be transmitted for recordal as an update to the inventory log 3.

The firing control system also carries out the firing initiation and recordal of consumption stage of the process, as represented by 4b. Upon recognition of the detonator code data, a firing signal is transmitted via data link 17 and a determination of a committed to fire state is made in the manner above described. In the particularly preferred embodiment, this takes the form of a committed to fire return signal which is generated by the detonator at the detonation site 2 and returned to the firing control 4b. However, as indicated, there are circumstances where it might be appropriate to infer a committed to fire state.

The generation of a firing initiation signal and the determination of a committed to fire state together cause the recordal of the detonator as consumed. This is effected via the data communication link 18 between the fire control centre and the inventory log. The recordal of destruction on the inventory log 3 is achieved with much greater degree of certainty than was possible with prior art systems.

1. A system for recording the use of detonators, the system comprising means to record electronically when a detonator is committed to fire; and means to make an entry in a data log to log as consumed a detonator so committed.

2. A system in accordance with claim 1 wherein the means to record electronically when a detonator is committed to fire records when a detonator is intrinsically committed to fire.

3. A system in accordance with claim 2 wherein the means to record electronically when a detonator is committed to fire records when a detonator is intrinsically and irrevocably committed to fire.

4. A system in accordance with claim 1 wherein a detonator is designed with an abort facility, the means to record electronically when a detonator is committed to fire records when a detonator is committed to fire, but operates to remove the log entry of detonator consumption in the event that an abort signal is given.

5. A system in accordance with claim 1 wherein the data log comprises an inventory control system to include at least data identifying all detonators supplied to and/or controlled store, data concerning whether consumption of a detonator has been recorded and data concerning whether a detonator has been removed from the store and/or whether a detonator has been deployed at a blast site.

6. A system in accordance with claim 1 further comprising a plurality of detonators and a firing control in communication with each detonator and with the data log, to send a fire initiation signal to each detonator and to record the identity of each detonator.

7. A system in accordance with claim 6 wherein the firing control also comprises means to determine and record electronically a committed to fire condition from each detonator.

8. A system in accordance with claim 1 wherein at least one detonator is provided with means to communicate a response confirming receipt of a signal initiating the detonator's commitment to fire, and is arranged so that on receipt of such an initiation signal the detonator is adapted to communicate a response that it is in receipt of the initiation signal, the system being configured such that only on receipt of such a response is the detonators consumption logged.

9. A system in accordance with claim 8 wherein the detonator is adapted to communicate a response that it is committed to fire.

10. A system in accordance with claim 9 wherein a detonator is adapted to generate a communication that it is committed to fire only once it has been irrevocably so committed.

11. A system in accordance with claim 9 wherein a detonator is adapted to allow detonation to be aborted following transmission of an initiation signal, by subsequent transmission of an abort signal, and the detonator is arranged so that on receipt of a signal initiating its explosion sequence the detonator communicates that it is committed to fire and a log is made of the detonator's consumption, but that on forwarding the abort command the detonator's consumption is removed from the log.

12. A system in accordance with claim 1 comprising a plurality of detonators in communication with a central firing control, each detonator adapted to transmit a unique identification code on interrogation from the central firing control.

13. A system in accordance with claim 1 wherein the data log comprises an electronic register.

14. A system in accordance with claim 13 wherein the data log comprises a secure electronic register.

15. A system in accordance with claim 14 wherein the data log is protected by a security system including suitable encryption and/or access controls, to be proof against or at least allow detection of tampering.

16. A method of recording the use of detonators comprising the steps of:
providing a fire control station in data communication with each detonator in use, using the fire control station to identify a “committed to fire” state for a detonator, in particular by receiving a committed to fire signal from the detonator following transmission of a firing initiation signal from the fire control station;
logging consumption based on the committed to fire state, and communicating the consumption of the detonator to a data log, to update the data log to register consumption of the identified detonator.

17. The method of claim 16 as an inventor control method, comprising the further steps of:
maintaining a data log comprising inventory data of identified detonators, including at least an identification of the detonators, and a recordal of whether they have been consumed;
logging consumption by updating the data log to register consumption of the identified detonator.

18. The method of claim 16 wherein the step of maintaining a data log additionally comprises recordal of supply of detonators to a controlled store, and recordal of removal of detonators for use.
